(19) United States
(12) Patent Application Publication
(10) Pub. No.: US 2014/0224137 A1
(43) Pub. Date: Aug. 14, 2014

(54) Method and Apparatus for Pressing Fruit

(71) Applicants: Dale Wettlaufer, Sarasota, FL (US); Eric Wettlaufer, West Falls, NY (US); Richard Hess, South Wales, NY (US)

(72) Inventors: Dale Wettlaufer, Sarasota, FL (US); Eric Wettlaufer, West Falls, NY (US); Richard Hess, South Wales, NY (US)

(21) Appl. No.: 14/177,296

(22) Filed: Feb. 11, 2014

Related U.S. Application Data
(60) Provisional application No. 61/762,995, filed on Feb. 11, 2013.

(51) Int. Cl. A23N 1/00

(52) U.S. Cl. CPC A23N 1/00
USPC 100/37; 99/495; 100/104; 100/207

(57) ABSTRACT

A method and apparatus for extracting juice from a previously de-juiced fruit mass which as been pressed within a primary press, the previously de-juiced fruit mass being discharged from the primary press and then being broken-up and mixed externally of the primary press, and then pressed again preferably by using a secondary thin layer repressing press which permits the repressed press cake to be quickly and easily loaded and emptied.

### TECHNICAL FIELD

The present invention relates generally to a process and extraction means for recovering a maximum amount of liquid from a given liquid containing mass, and more particularly to a method and apparatus for extracting juice from a previously de-juiced fruit mass which as been pressed within a press, the previously de-juiced fruit mass being discharged from the press and then being broken-up and mixed, and then pressed again preferably by using a thin layer press which is quickly and easily loaded and emptied.

### BACKGROUND OF THE INVENTION

The problem of extracting all the available juice from juice bearing cells in fruit has been dealt with extensively in the prior art. Although centrifuging is sometimes used, most juice is pressed using some sort of pressing device. Even though there are many presses in use that squeeze just once it is very difficult to extract all the juice no matter how hard one presses. Although it is generally acknowledged that the first pressing for a fruit mass yields the most desirable “first run” juice, it has also become obvious that with ever increasing fruit prices, no juice producer can afford to ignore the residual juice which is “locked” within the pressed “cake” after it has been squeezed the first time. Sometimes the first run juice is used for the premium product, and the subsequent juice sold at a lower price. Sometimes it is all combined, as is usually the case when the final product is a concentrate.

Prior art has taught the technique of multiple repressings within the same press by repeatedly interrupting the squeezing cycle, relieving the pressure on the fruit mass, breaking up or mixing the fruit mass and redistributing it within the press, and then repressing the same fruit mass, in some cases repeating the process as many as 30 times. Each additional repressing yields a diminishing but still useable amount of extra juice. Example of this technique is shown the U.S. Pat. No. 3,207,064 to Hauser-Bucher.

Although the practice of repressing is useful and has been perfected over time, there are still several shortcomings when one attempts to extract the first run juice and also to mix and repress within a single pressing device. These shortcomings result from the attempt to accomplish two very different tasks in the same machine.

To explain this, let us look at fruit to be squeezed. After maceration, a fruit mash yields its first juice easily and quickly so long as there is ample surface area to allow the juice to exit. This is why the first juice is often called the “free run” because it runs so freely. So the first task of a juice press is to provide ample surface area, often leading to a relatively large machine. Many patents have been granted for different types of drainage elements and the like which facilitate this free run juice.

Once the freely available juice has run out the second main task of a press is to be able to apply pressure to the mash after the free run juice has exited. This pressure is typically increased over time until it reaches 100 psi or more on the cake. These types of forces, measured in many tons, necessitate the need for robust construction, heavy weldments, thick material etc, leading to high costs of manufacture.

It should be obvious that the attempt to provide a machine that can accomplish both the above tasks would have to be relatively large with a lot of surface area, and also robust in construction to withstand large forces. This leads to expensive massive machines.

When one looks at the mathematics of the process it becomes more obvious that this pressing process might be better accomplished using two disparate machines. One with large surface area for drainage, and the other smaller, more heavily built to squeeze the final juice out of a much smaller volume of fruit mash. During a typical pressing cycle the percentage of juice remaining in the mash being pressed progressively decreases in time. Thus, during the first 8 minutes of pressing the juice content in the mash being pressed decreased from 100% to 22%. Thus, 78% of the juice was extracted during the first 8 minutes of pressing. As pressing was continued, 18% if the juice remained after 16 minutes of continuous pressing, 17.5% remained after 24 minutes of pressing, 14% of the juice remained after 32 minutes of pressing, 10.5% juice remained after 40 minutes, 9.5% remained after 48 minutes, and finally 8% remained after 56 minutes of continuous pressing. The majority of the juice was obtained in the first 8 minutes. And yet the profit-conscious juice producer must hold for another 48 minutes (typical cycle time of 56 minutes) to avoid throwing away valuable product. The unfortunate reality of this fact means that in most juice factories of the world, if one were to randomly select a given press during its daily pressing regimen, most likely one would find that this machine is extracting small squirts of juice from small volumes of “cake” that are rattling around in a big empty chamber. It is a strikingly poor use of a high capital piece of equipment. It would be far more economical to exit the “cake” after 8 or 10 minutes, so that the primary press could refill and process far more fruit mash in a given time period. The partially dejuiced cake could than be handed off to a secondary press that could be much smaller in size and more robust in character, whose task it would be to “wring” out the remaining 10% of the juice that is left behind in the cake after the first pressing.

### OBJECTS AND SUMMARY OF THE INVENTION

It is an object of the present invention to initially press a macerated fruit mash to extract free run juice, and then, after the initial pressing, to breakup the pressed cake from the first pressing, and use a thin-layer repressing mechanism which can accept broken pressed cake. Ideally this repressing device should be able to accept the broken cake easily and quickly, and to eject it rapidly. The reason this needs to be done rapidly is because the present invention teaches the re-cycling of the cake again and again back into the same repressing mechanism.

In one embodiment of this invention a thin layer press of the type shown in U.S. Pat. Nos. 4,892,665 and 5,275,097 is employed, and presses of this type are used to do the initial or primary press and the secondary repress. A second embodiment shows similar presses of the type shown in U.S. Pat. Nos. 4,892,665 and 5,275,097, one for the initial press and one for the repress. The second repress can be either a single repress or preferably multiple represses. In all of these designs the cake is removed from the initial or primary thin layer press and broken up, in for example a pug mill, a hammer mill, or any other suitable device. A screening device may be used to insure that all of the broken up cake is smaller than a predetermined size, for example 1.5 inch chunks. After the press cake from the initial or primary press is broken up and screened to proper size, it is introduced into a thin layer secondary or repressing press which can be quickly and easily loaded and emptied.

### BRIEF DESCRIPTION OF THE FIGURES

FIG. 1 shows a schematic view of a first embodiment of a juice system having two presses, the second press doing only a single repress, which second press is a thin layer press which is easily and quickly loaded and emptied.

FIG. 2 shows a schematic view of a second embodiment of a juice system having two presses, the second repress press capable of multiple represses.

FIGS. 3a and 3b show the juice system of FIG. 2 in greater detail.

### DETAILED DESCRIPTION

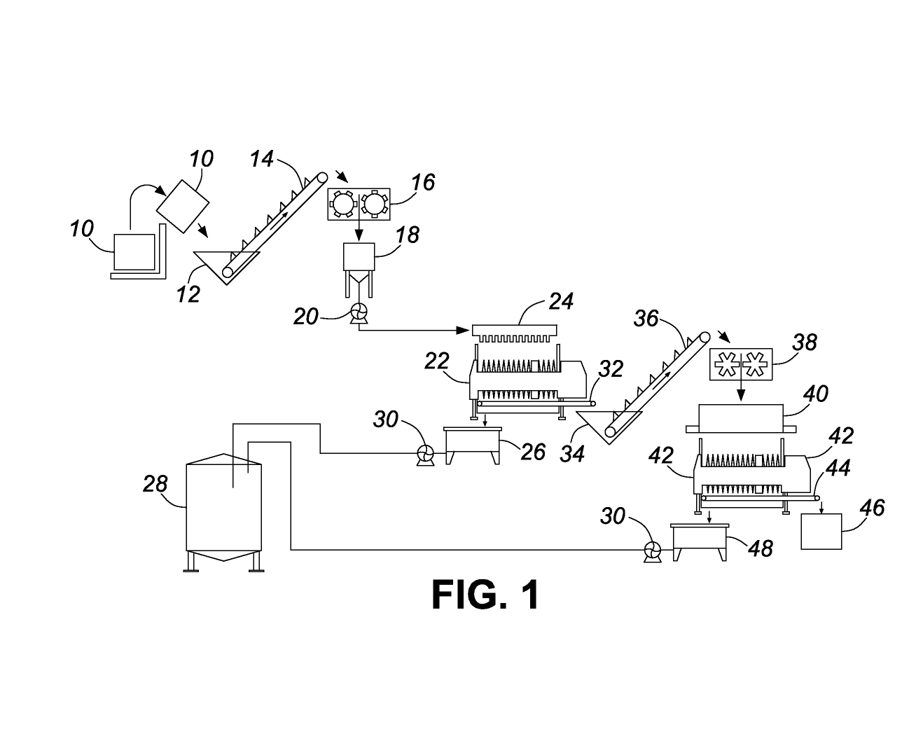

Initially, FIG. 1 illustrates a first embodiment of the present invention, various components being illustrated somewhat schematically, and showing the overall process for extracting juice from fruit. The fruit is initially received in large boxes or bins 10 which are dumped into a hopper 12 associated with a conveyor 14 which conveys the fruit to a suitable grinder 16 which turns the fruit into a mash which is then dumped into a surge tank 18 for flow into a pump 20. The illustrated grinder is a pug mill having two shafts. However, other devices may be used to create a fruit mash such as hammer mills, shredders, graters, etc.

The pump 20 pumps fruit mash to a primary thin layer press 22 of the type shown in U.S. Pat. Nos. 4,892,665 and 5,275,097, the mash being introduced into the primary press via a nozzle filler 24. In the design illustrated in FIG. 1, the pump 20 is the primary pump. Once the primary press is suitably filled, the operation of the pump is discontinued, and the primary press commences operation. In the present design the primary press is operated for only about 8 to 10 minutes, which is sufficient to release the free run juice which is then collected in primary and secondary tanks 26, 28, a pump 30 being used to move the juice from the primary tank 26 to secondary tank 28.

In accordance with the present invention, after the free run juice has been discharged from the primary press 22, the pressing is discontinued, and the portion of the press which contains the pressed fruit mash is inverted to discharge the partially dejuiced press cake or pomace from the primary thin layer press 22 onto a conveyor 32, which conveys the partially dejuiced press cake to a hopper 34 and inclined conveyor 36 which discharges the cake into a device 38 for breaking up and mixing the partially dejuiced press cake. It has been found that the press cake should be broken into pieces no more than 1.5 inches across. To this end the device 38 may include a screen (not shown) to insure that pieces bigger than 1.5 inches are retained until they are broken into smaller size pieces. The device 38 may be another pug mill, or any other device suitable for breaking up and mixing the press cake, the product of the device 38 having all pieces smaller than 1.5 inches in diameter.

The broken-up pieces of the press cake are now discharged into a hopper filler 40 which is used to fill secondary thin layer press 42 of the type shown in U.S. Pat. Nos. 4,892,665 and 5,275,097. This press has multiple vertical chambers which enable the pressing of thin layers with greater force than the primary press. Thus, since the repressing press is capable of applying a greater force to the pomace within the repress press, it is capable to extract the residual juice which was not extracted by the primary press. In addition, the secondary press is preferably a thin layer press because it can be more quickly loaded and emptied than other types of presses, and also because it is possible to extract more juice using this type of press because it has a large surface area. The thin layer repressing press preferably has surface areas less that the surface areas of the primary press. At the conclusion a the second pressing, typically only about 8-10 minutes, the repressed cake is discharged by inverting the thin layer portion of the press 42, causing the repressed cake to be discharged onto another conveyor 44, the repressed cake in this embodiment being discharged into a pomace waste bin 46. The juice extracted during this repressing flows into a secondary press juice tank 48, and then is pumped via pump 50 into the primary juice tank 28. It has been found that the juice from the repressed fruit cake is good quality juice, as good as the free run juice, and in addition, it may have a higher sugar content.

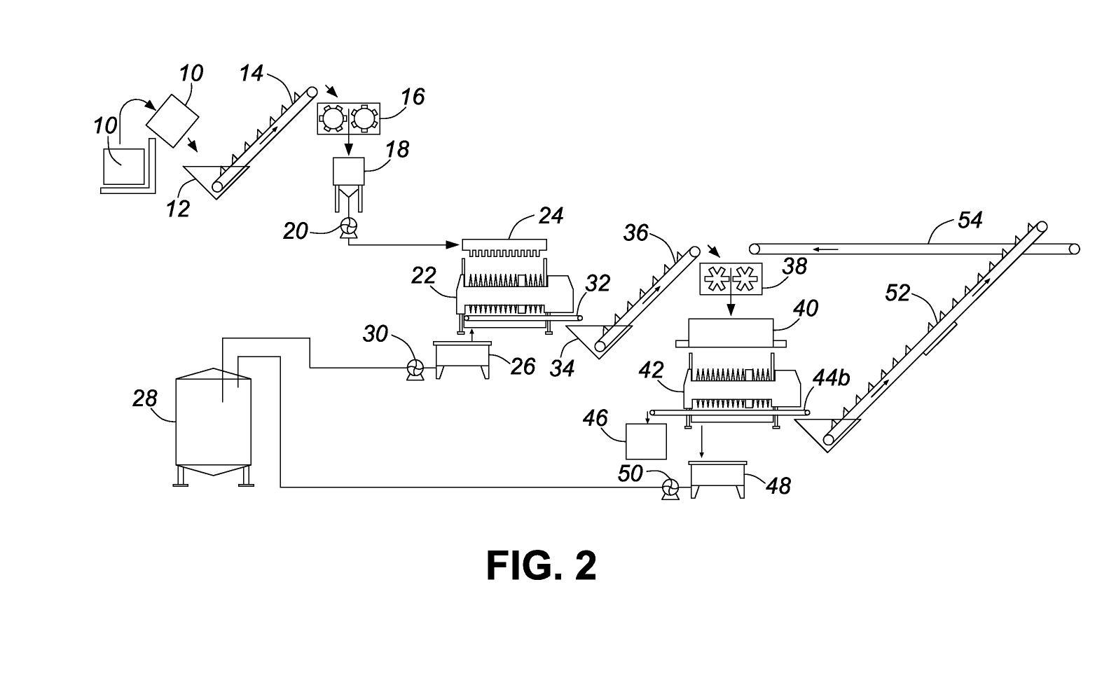

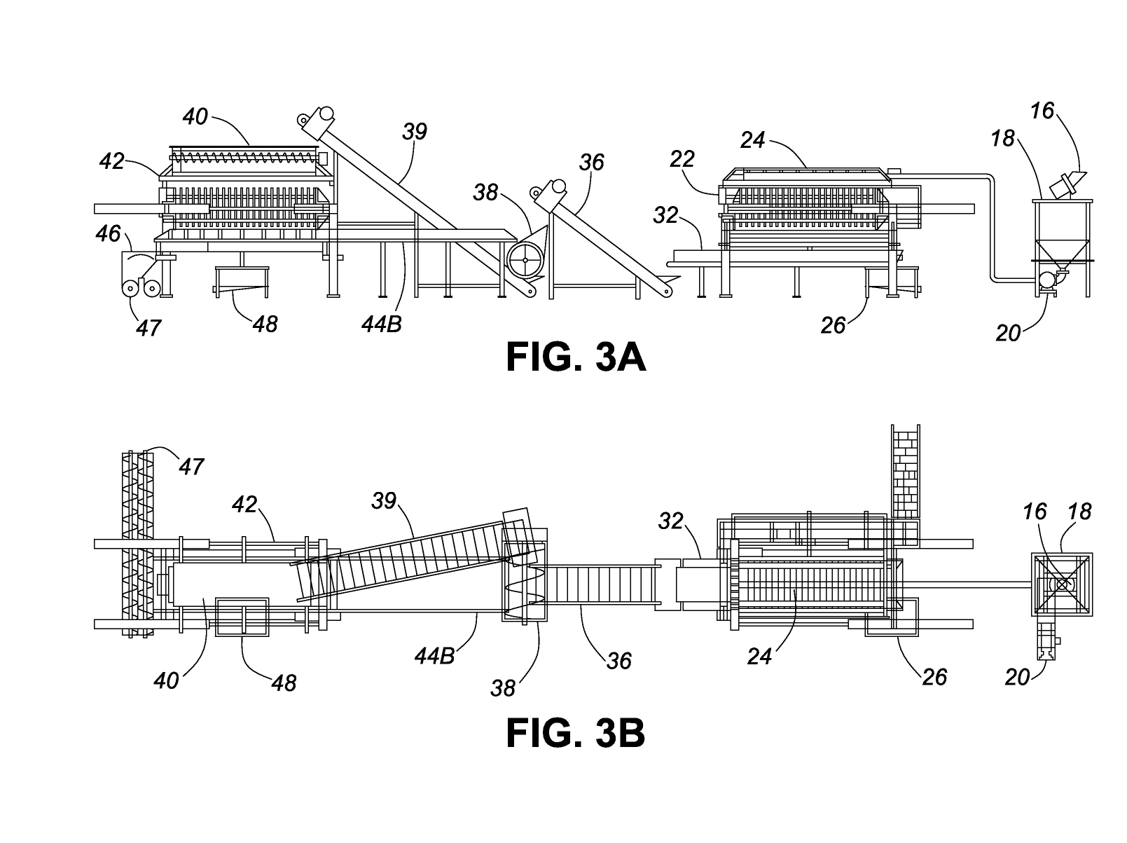

With reference now to FIGS. 2, 3A, and 3B a variation of the design shown in FIG. 1 is illustrated where it is possible to recycle the repressed cake back into the secondary press or repress press. In these figures, the same reference numerals refer to the same parts shown in FIG. 1. The primary difference is that the conveyor 44b under the represser press bi-directional. In the FIG. 2 design this permits the repress cake to be transported back to the hopper filler 40 via first and second conveyors 52, 54. In the FIGS. 3A and 3B layouts the repressed press cake is transported back to a mixer 38 for recycling, the mixer breaking up the press cake. As can be seen from FIGS. 3A and 3B, the mixer 38 receives press cake from the conveyor or elevator 36 which receives press cake from the primary stage press 22, and also press cake from the secondary press 42. To this end, the bidirectional cake conveyor 44b located under the secondary press 42 is extended so that its discharge is far enough away from the secondary press that the blender 38 can discharge the broken up press cake onto a single cake elevator 39 which in turn discharges the broken-up press cake into a hopper filler 40. When desired, the operator will reverse the bidirectional cake conveyor 44B to cause the essentially dry press cake to be discharged into the waste bin 46. Twin waste cake augers 47 extend away from the hopper 46.

While preferred forms of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. Method for pressing fruit comprising the following steps:
forming a fruit mash;
putting the mash into a primary thin layer press;
pressing the fruit mash in the primary thin layer press for a limited length of time in order to allow free run juice to exit quickly;
discharging the partially dejuiced press cake from the primary thin layer press after it has been in there for a limited length of time;
externally breaking up and mixing the discharged partially dejuiced press cake;
putting the broken up and mixed partially dejuiced press cake into a secondary repress press; and
repressing the broken-up and mixed partially dejuiced press cake in the secondary repress press to extract residual juice.

2. The method as set forth in claim 1 wherein the free run juice and the residual juice are combined together in a juice tank.

3. The method as set forth in claim 1 wherein the primary press is a thin layer press which receive the fruit mash and the secondary repress press which receives the broken up and mixed partially dejuiced press cake applies a greater pressing force than is applied by the primary press.

4. The method as set forth in claim 3 wherein the repressed cake may be broken up and mixed a further time for repressing.

5. The method as set forth in claim 3 wherein the secondary press is a thin layer press.

6. An apparatus for pressing fruit comprising the following:
means for forming a fruit mash;
a primary thin layer press;
means for putting the mash into the primary thin layer press;
means for pressing the fruit mash in the thin layer press for a limited length of time to extract free run juice;
means to discharge the partially dejuiced press cake from the primary thin layer press after a limited length of time;
means for breaking up and mixing the partially dejuiced press cake after it has been discharged from the primary thin layer press;
introducing the broken-up and mixed partially dejuiced press cake into a secondary repressing press;
repressing the broken-up and mixed partially dejuiced press cake to extract additional residual juice; and
discharging the repressed cake.

7. The apparatus set forth in claim 6 wherein the primary press is a thin layer press and the secondary repressing press which receives the broken up and mixed partially dejuiced press cake is capable of applying a greater force than the primary thin layer press.

8. The apparatus as set forth in claim 7 wherein means are provided to transport the discharged repressed cake to the means for breaking up and mixed so that the discharged press cake can be recycled.

9. The apparatus as set forth in claim 6 wherein the secondary repressing press which received the partially dejuiced press cake is a thin layer press.
